(19) United States
(12) Patent Application Publication
(10) Pub. No.: US 2011/0312335 A1
(43) Pub. Date: Dec. 22, 2011

(54) CELLULAR LOCATION SYSTEM AND CELLULAR LOCATION METHOD

(76) Inventors: Jun LIU, San Marcos, CA (US); Hafedh Trigui, Ottawa (CA); Richard Cuthill, Reston, VA (US)

(21) Appl. No.: 12/818,440

(22) Filed: Jun. 18, 2010

(51) Int. Cl. H04W 24/00; H04W 36/00; H04W 4/00

(52) U.S. Cl. 455/456.1; 455/67.11

(57) ABSTRACT

A cellular location method is used in a cellular location system including a database. The cellular location method obtains radio measurements from a user terminal located in the communications network, extracts information from the obtained radio measurements, determines the location of the user terminal based on the extracted information, and stores the determined location of the user terminal and the extracted information as an entry in the database such that the determined location of the user terminal is retrieved based upon a matching score between the extracted information from the user terminal and extracted information from the specified user terminal. Additionally, when the determined location of the user terminal is retrieved based upon the matching score, the location of the specified user terminal is determined to be the determined location of the user terminal.

### BACKGROUND OF THE INVENTION

1. Field of the Invention

The present invention relates to a cellular location system and a cellular location method in a communications network, and more particularly, to a cellular location system and a cellular location method in which the location of a user terminal is determined via database correlation.

2. Description of the Related Art

Techniques for determining the location of a user terminal in a cellular network can generally be classified into the following three categories.

The first category for determining the location of a user terminal in a cellular network is that the location of the user terminal may be determined by way of a Global Positioning System (“GPS”) or an Assisted Global Positioning System (“AGPS”). However, in order for GPS or AGPS to be used, it is required that the user terminal include a GPS or an AGPS receiver. Accordingly, GPS or AGPS is not always available to be used to determine the location of a user terminal since some user terminals may not be equipped with a GPS or an AGPS receiver. Additionally, this technique suffers from the drawback that position related measurements are not available unless the user terminal or the other cellular network equipment initiates a location request.

The second category for determining the location of a user terminal in a cellular network involves obtaining Time Of Arrival (“TOA”) or Time Difference Of Arrival (“TDOA”) measurements from the user terminal or other cellular network equipment. As with GPS or AGPS, a location system based on TOA or TDOA is not always available to be used as the user terminal or the other cellular network equipment must be configured to obtain TOA or TDOA measurements. Additionally, as with GPS or AGPS, location determination by TOA or TDOA suffers from the drawback that position related measurements are not available unless the user terminal or the other cellular network equipment initiates a location request.

The third category for determining the location of a user terminal in a cellular network involves database correlation between stored user terminal measurements and obtained user terminal measurements to determine a location of the user terminal. In database correlation, a database is built from previously obtained general radio measurements and/or predicted general radio values.

After a database is sufficiently built up, a location of a user terminal can be readily determined by a mobile or base station using general radio measurements obtained from the user terminal. In such a system, the obtained measurements are compared to entries within the database, and a best matching database entry (which includes an estimated location for the user terminal) is found using a predetermined method.

In a conventional cellular location system employing database correlation, prior general radio measurements are typically obtained by technicians traveling to various spots within the cellular network, and using specialized equipment to obtain on-site general radio measurements. However, if the cellular network area is large, using the above method to obtain data for the database can be very expensive and time-consuming.

In order to solve the above problem, other conventional cellular location systems employing database correlation obtain fewer on-site general radio measurements, and subsequently, use prediction tools (e.g., propagation models of the cellular network) to obtain predicted values for locations where on-site general radio measurements were not obtained. While this alterative conventional method reduces the cost needed to build up a database, the predicted values are subject to significant calibration in order to obtain accurate values.

In view of the above deficiencies in the prior art, there exists a need for an efficient and effective cellular location system and cellular location method employing database correlation.

### SUMMARY OF THE INVENTION

An embodiment of the present invention relates to a cellular location method for determining the location of a specified user terminal in a communications network in which a database containing user terminal measurements and corresponding locations is built up over time and location. In particular, the cellular location method obtains radio measurements from a user terminal located in the communications network, extracts information from the obtained radio measurements, determines the location of the user terminal based on the extracted information, and stores the determined location of the user terminal and the extracted information as an entry in the database. A location of the specified user terminal can be obtained via the database based on a matching score between measurements from the specified user terminal and the stored user terminal measurements.

An embodiment of the present invention includes a cellular location system for determining the location of a specified user terminal in a communications network in which a database containing user terminal measurements and corresponding locations is built up over time and location. In particular, the cellular location system includes an obtaining unit for obtaining radio measurements from a user terminal located in the communications network, an extracting unit for extracting information from the obtained radio measurements, a determining unit for determining the location of the user terminal based on the extracted information, and a database for storing the determined location of the user terminal and the extracted information as an entry in a database. A location of the specified user terminal can be obtained via the database based on a matching score between measurements from the specified user terminal and the stored user terminal measurements.

An embodiment of the present invention relates to a non-transitory computer readable recording medium having recorded thereon a cellular location program that when executed causes a computer to perform a cellular location method for determining the location of a specified user terminal in a communications network in which a database containing user terminal measurements and corresponding locations is built up over time and location. In particular, the cellular location method obtains radio measurements from a user terminal located in the communications network, extracts information from the obtained radio measurements, determines the location of the user terminal based on the extracted information, and stores the determined location of the user terminal and the extracted information as an entry in the database. A location of the specified user terminal can be obtained via the database based on a matching score between measurements from the specified user terminal and the stored user terminal measurements.

### BRIEF DESCRIPTION OF THE DRAWINGS

FIG. 1 illustrates an exemplary implementation of a cellular network including a cellular location system in accordance with an embodiment of the present invention.

FIG. 2 illustrates a flowchart for building up a database within a cellular location system in accordance with an embodiment of the present invention.

FIG. 3 illustrates a flowchart for determining a location of a user terminal in accordance with an embodiment of the present invention.

FIG. 4 illustrates a representative cellular location system as shown in the cellular network of FIG. 1 in accordance with an embodiment of the present invention.

### DETAILED DESCRIPTION OF THE INVENTION

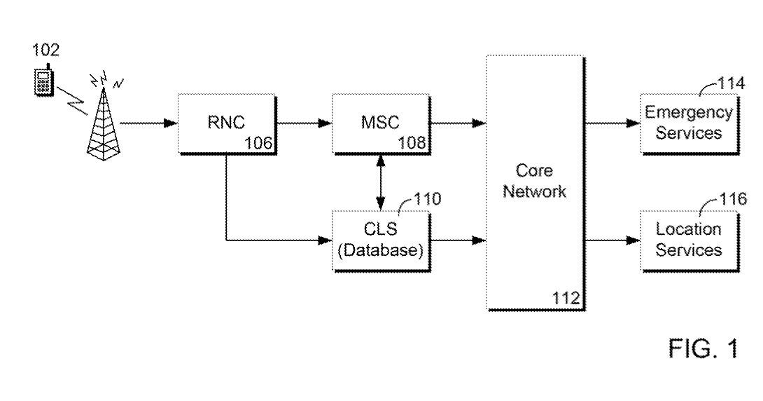

FIG. 1 illustrates an exemplary implementation of a cellular network including a cellular location system in accordance with an embodiment of the present invention. It should be noted that the present invention is not limited to the embodiment illustrated in FIG. 1, and that one of ordinary skill in the art would find it apparent that the present invention may be differently implemented.

In FIG. 1, the cellular location system 110 (“CLS”) interfaces with a user terminal 102 via a radio network controller 106 (“RNC”) in order to obtain radio measurements from the user terminal 102. The radio measurements obtained by the RNC 106 are then compared to entries stored in the database within the CLS 110 to determine a location of the user terminal 102. Additionally, the CLS 110 can interface directly with the core network 112 to transmit the determined location information of the user terminal 102 to location services 116, or in conjunction with a mobile switching center (“MSC”) 108, transmit the determined location information of the user terminal 102 to emergency services 114.

The CLS 110 will be further described below with reference to a Universal Mobile Telecommunications System (“UMTS”) in accordance with an embodiment of the present invention. However, it should be noted that the present invention is not limited to such an embodiment, and it should be apparent to one of ordinary skill in the art that the present invention can be easily modified so as to be employed in different telecommunication systems.

In UMTS, the user terminal (hereafter “UT”) maintains a list of cells within a cellular network to be monitored. The UT selection of a cell into an active set of cells is based on certain criteria which may include, but is not limited to, whether or not a received signal strength from a cell exceeds a threshold, or if a received signal quality (as measured by the usable part of the RF signal, “Ec/Io”) exceeds a threshold.

For the purposes of this disclosure, the cellular network is an exemplary cellular network in which a network area is partitioned into small regions, with the center of each region being referred to as a “pixel.” Accordingly, a pixel location (xᵢ, yᵢ) represents one region within the cellular network area.

The above partitioning of the cellular network area allows the database within the CLS 110 to be constructed as a look-up table containing any location sensitive parameters available at each pixel location. As an example, Table 1 is illustrated below in which downlink path loss and UT Rx-Tx time difference values (marked by “l” and “t”, respectively) are stored as a look-up entry in the database within the CLS 110.

TABLE 1
Example structure of the look-up table

| Location Pixel | Cell 1 | Cell 2 | Cell 3 | . . . | Cell n |
|---|---|---|---|---|---|
| (x₁, y₁) | (l_{1,1}, t_{1,1}) | (l_{2,1}, t_{2,1}) | (l_{3,1}, t_{3,1}) | . . . | (l_{n,1}, t_{n,1}) |
| (x₂, y₂) | (l_{1,2}, t_{1,2}) | (l_{2,2}, t_{2,2}) | (l_{3,2}, t_{3,2}) | . . . | (l_{n,2}, t_{n,2}) |
| . . . | . . . | . . . | . . . | . . . | . . . |
| (xᵢ, yᵢ) | (l_{1,i}, t_{1,i}) | (l_{2,i}, t_{2,i}) | (l_{3,i}, t_{3,i}) | . . . | (l_{n,i}, t_{n,i}) |
| . . . | . . . | . . . | . . . | . . . | . . . |

With reference to Table 1, let n be the number of measured cells within the cellular network, and let E(xᵢ, yᵢ) be a look-up entry at the pixel location (xᵢ, yᵢ) and be illustrated by equation (1.1) below.

E(xᵢ, yᵢ)=[(l_{1,i}, t_{1,i}), (l_{2,i}, t_{2,i}), (l_{3,i}, t_{3,i}), . . . , (l_{n,i}, t_{n,i})] (1.1)

where l_{1,i}, l_{2,i}, . . . , l_{n,i} are power values (such as the downlink path loss) on n measured cells at the pixel location (xᵢ, yᵢ), and t_{1,i}, t_{2,i}, . . . , t_{n,i} are time values (such as the UT Rx-Tx time difference) on n measured cells at the pixel location (xᵢ, yᵢ).

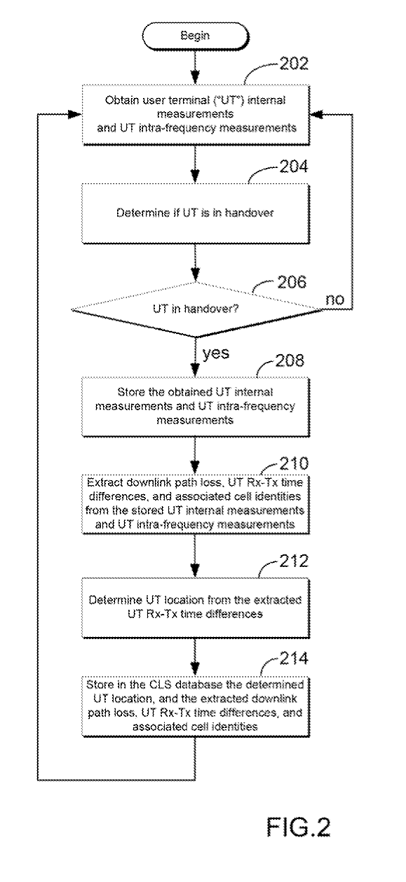

FIG. 2 illustrates a flowchart for building up a database within the CLS 110 in accordance with an embodiment of the present invention. After initialization, at Step 202, the CLS 110 obtains UT internal measurements for each active cell and UT intra-frequency measurements for each active cell as well as each neighbor cell.

The UT internal measurements may include, but are not limited to, any of the following: UT transmission (“Tx”) power; UT received signal strength power (“RSSI”); or UT Rx-Tx time difference. The UT Rx-Tx time difference is sometimes referred to as the propagation delay, and is the roundtrip time between the UT and an active cell.

The UT intra-frequency measurements may include, but are not limited to, any of the following: cell identity; downlink carrier to noise ratio (“Ec/N0”); and downlink path loss.

At Step 204, the CLS 110 determines if the UT is in handover based on the obtained UT internal measurements and UT intra-frequency measurements. In a UMTS system, when in handover, the UT has more than one cell in the active set. This results in the UT performing measurements on and establishing a radio link with each cell in the active set. Accordingly, if the UT internal measurements include values for two or more active cells, it is determined that the UT is in handover.

At Step 206, if the CLS 110 determines that the UT is not in handover, the process is repeated from Step 202. If it is determined that the UT is in handover, the CLS 110, at Step 208, temporarily stores in a memory the obtained UT internal measurements and UT intra-frequency measurements.

At Step 210, the CLS 110 extracts any values of downlink path loss, UT Rx-Tx time differences, and any associated cell identities from the stored UT internal measurements and UT intra-frequency measurements.

At Step 212, the location of the UT is determined based on the extracted UT Rx-Tx time differences. In this regard, it should be noted that the accuracy requirement for the UT Rx-Tx time difference is +/−1.5 chips. As a result, given the one-way propagation time is half of the UT Rx-Tx time difference, the range error of the UT and the active cell is +/−58.5 meters. If the ranges between the UT and two or more active cells are known, the UT location can be estimated by using a non-linear least-squares solution or other suitable methods (which are outside the scope of the present disclosure).

At Step 214, an entry is created in the database within the CLS 110 in which the extracted values of the downlink path loss, the UT Rx-Tx time differences, and the associated cell identities, along with the corresponding determined UT location are stored. The process is then repeated in order to build up the database within the CLS 110 over time and location. Additionally, it should be noted that there exist alternative methods for using the determined locations of user terminals in the database. As an example, for all determined locations of user terminals that fall into a region, their estimated location vectors may be averaged as one common vector, and the estimated location is represented by the pixel location (xᵢ, yᵢ) representing the region.

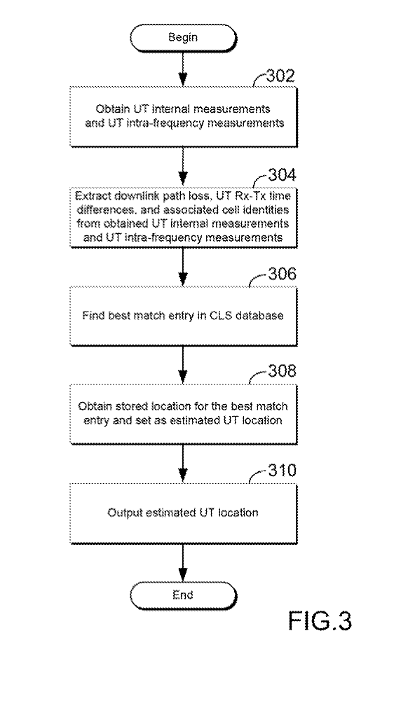

FIG. 3 illustrates a flowchart for determining a location of a user terminal in accordance with an embodiment of the present invention. After initialization, at Step 302, the CLS 110 obtains UT internal measurements and UT intra-frequency measurements.

At Step 304, the downlink path loss, UT Rx-Tx time differences, and any associated cell identities are extracted from the obtained UT internal measurements and UT intra-frequency measurements. Assuming a set of power measurements l₁, l_{2 . . .} lₙ (e.g., the downlink path loss) and a set of time measurements t₁, t₂ . . . tₙ (e.g., the UT Rx-Tx time difference) from the UT are available for all n measured cells, a corresponding measurement vector, M, for the UT may be represented as shown in equation (1.2):

M=[(mₗ₁,mₜ₁), (mₗ₂,mₜ₂), (mₗ₃,mₜ₃), . . . , (mₗₙ,mₜₙ)] (1.2)

where mₗ₁, mₗ₂, mₗₙ are power measurements (e.g., the downlink path loss) and mₜ₁, mₜ₂, mₜ₃, . . . , mₜₙ are time measurements (e.g., the UT Rx-Tx time difference) at the current UT location.

As Step 306, the best match entry in the CLS database 110 can be determined by computing a matching score from the deviation of the entries E(xᵢ,yᵢ) in the look-up table and M by a predetermined method. For example, the matching score may be computed, but is not limited to, using the method of least-mean squares (“LMS”). In this instance, the LMS score Sᵢ is given by equation (1.3):

Sᵢ=∥E(xᵢ,yᵢ)−M∥=α Σₖ₌₁ⁿ|l_{k,i}−mₗₖ|+β Σₖ₌₁ⁿ|t_{k,i}−mₜₖ| (1.3)

where α is a weighting for power measurements, β is a weighting for time measurements, and |.| is the absolute operation. It should be noted that in equation (1.3), Sᵢ is determined by the least absolute values, which is a special case of LMS. Different values for the weighting coefficients, α and β, may be needed depending on the availability and quality of measurement parameters.

It should be noted that in a UMTS network, the UT is able to make power measurements (e.g., downlink path loss) on more cells than timing measurements (e.g., UT Rx-Tx time difference). Accordingly, power measurements and timing measurements may be used separately.

For example, when the UT is not in handover, only the UT Rx-Tx time difference for the serving cell (i.e., the single active cell) is available. As a result, only the entries having the serving cell and within a corresponding propagation time accuracy range are selected for matching. Further, β can set to 0 (i.e., β=0) in order to facilitate a more efficient search. In such a case equation (1.3) is reduced to equation (1.4) below.

Sᵢ=Σₖ₌₁ⁿ|l_{k,i}−mₗₖ| (1.4)

Alternatively, when the UT is in handover, two or more UT Rx-Tx time differences are available from the two or more active cells. As a result, the two or more UT Rx-Tx time differences may be used to compute an estimated location of the UT by using a non-linear least-squares solution or other suitable methods (which are outside the scope of the present application). Additionally, the UT location estimation according to power measurements using equation (1.4) may provide assistance information to the location estimation process from the two or more UT Rx-Tx time differences.

At Step 308, the pixel location (xᵢ, yᵢ) in the look-up table corresponding to the minimum value of Sᵢ is considered the best match entry, and pixel location (xᵢ, yᵢ) is determined to be the location of the UT having the measurement vector M.

At Step 310, the CLS 110 outputs the pixel location (xᵢ, yᵢ) as the location of the UT.

Additionally, it should be noted that the determined location of the UT is not limited to a single pixel location (xᵢ, yᵢ) as the best match entry in the database, and other methods to determine the location of the UT based on the information stored in the database should be apparent to one of ordinary skill in the art. For example, the CLS 110 may extract two or more of the closest matching entries to the measurement vector M based on the calculated values of Sᵢ, and perform a method of interpolation to determine the location of the UT based on the relative values of Sᵢ for each of the closest matching entries and the corresponding pixel locations.

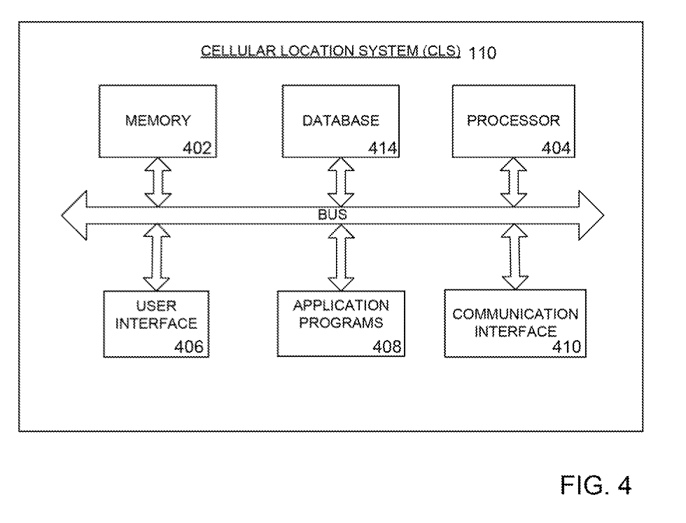

FIG. 4 is a representative Cellular Location System 110 as shown in the communications system of FIG. 1. In FIG. 4, the CLS 110 includes a memory 402, a processor 404, user interface 406, application programs 408, communication interface 410, a bus 412, and a database 414.

The processor 404 can be a grouping of one or more processors for performing the necessary functions of the CLS 110. For example, UT measurements obtained by the CLS 110 via the RNC 106, can be processed by a data processor to form the location sensitive entries in the database 414. Similarly, UT measurements obtained by the CLS 110 via the RNC 106, for comparison to the entries within the database 414 can be processed by a match processor for comparing and determining the best match as the determined UT location.

The memory 402 can be computer-readable media used to store executable instructions, computer programs, algorithms or the like thereon. The memory 402 may include a read-only memory (ROM), random access memory (RAM), programmable read-only memory (PROM), erasable programmable read-only memory (EPROM), a smart card, a subscriber identity module (SIM), or any other medium from which a computing device can read executable instructions or a computer program. The term “computer programs” is intended to encompass an executable program that exists permanently or temporarily on any computer-readable medium. The instructions, computer programs and algorithms stored in the memory 402 cause the CLS 110 determine the location of UT as described above. The instructions, computer programs and algorithms stored in the memory 402 are executable by one or more processors 404, which may be facilitated by one or more of the application programs 408.

The application programs 408 may also include, but are not limited to, an operating system or any special computer program that manages the relationship between application software and any suitable variety of hardware that helps to make-up a computer system or computing environment of the CLS 110. General communication between the components in the CLS 110 is provided via the bus 412.

The user interface 406 allows for interaction between a user and the CLS 110. The user interface 406 may include a keypad, a keyboard, microphone, and/or speakers. The communication interface 410 provides for two-way data communications from the CLS 402. By way of example, the communication interface 410 may be a digital subscriber line (DSL) card or modem, an integrated services digital network (ISDN) card, a cable modem, or a telephone modem to provide a data communication connection to a corresponding type of telephone line. As another example, communication interface 410 may be a local area network (LAN) card (e.g., for Ethernet™ or an Asynchronous Transfer Model (ATM) network) to provide a data communication connection to a compatible LAN.

Further, the communication interface 410 may also include peripheral interface devices, such as a Universal Serial Bus (USB) interface, a Personal Computer Memory Card International Association (PCMCIA) interface, and the like. The communication interface 1010 also allows the exchange of information across one or more wireless communication networks. Such networks may include cellular or short-range, such as IEEE 802.11 wireless local area networks (WLANS). And, the exchange of information may involve the transmission of radio frequency (RF) signals through an antenna (not shown).

While the above described embodiment has been discussed with reference to a UMTS network, it should be noted the present invention may be easily applied to a code division multiple access (“CDMA”) network. In a CDMA network, a UT obtains pilot phase measurements on cells in both the active and neighbor cells. Such measurements contain the entire necessary information equivalent to UT internal/intra-frequency measurements by a UT in a UMTS network.

While the above embodiments of the invention have been disclosed, numerous modifications and changes will occur to those skilled in the art to which this invention pertains. The claims annexed to and forming a part of this specification are intended to cover all such embodiments and changes as fall within the true spirit and scope of the present invention.

1. A cellular location method for determining a location of a specified user terminal in a communications network, said cellular location method being used in a cellular location system including a database, said cellular location method comprising:
obtaining radio measurements from a user terminal located in the communications network;
extracting information from the obtained radio measurements such that the location of the user terminal can be determined;
determining the location of the user terminal based on the extracted information; and
storing the determined location of the user terminal and the extracted information as an entry in the database such that the determined location of the user terminal is retrieved based upon a matching score between the extracted information from the user terminal and extracted information from the specified user terminal.

2. The cellular location method of claim 1, wherein said obtaining radio measurements from the user terminal is performed when the user terminal is in handover.

3. The cellular location method of claim 1, wherein when the determined location of the user terminal is retrievable based upon the matching score between the extracted information from the user terminal and the extracted information from the specified user terminal, the location of the specified user terminal is determined based on the determined location of the user terminal.

4. The cellular location method of claim 1,
wherein the extracted information from the user terminal is stored as an estimated location vector including one or more power values and one or more time measurements for each of n available cells within the communications network,
wherein the extracted information from the specified terminal is represented as a measurement vector including one or more power values and one or more time measurements for each of n available cells within the communications network, and
wherein the matching score is computed by calculating a least-mean squares (LMS) difference between the estimated location vector and the measurement vector.

5. The cellular location method of claim 4,
wherein a coefficient weighting, α, is used for calculating an LMS difference between the one or more power values of the estimated location vector and the one or more power values of the measurement vector,
wherein a coefficient weighting, β, is used for calculating an LMS difference between the one or more time values of the estimated location vector and the one or more time values of the measurement vector,
wherein α and β are different values, and
wherein the LMS difference between the estimated location vector and measurement vector is the sum of the LMS difference between the one of more power values and the LMS difference between the one or more time values.

6. The cellular location method of claim 2,
wherein said extracting information from the obtained radio measurements includes extracting a propagation delay between the user terminal and two or more cells within the communications network, and
wherein the location of the user terminal is determined based on the extracted propagation delay between the user terminal and the two or more cells within the communications network.

7. The cellular location method of claim 6,
wherein said extracting information from the obtained radio measurements includes extracting a downlink path loss between the user terminal and two or more cells within the communications network, and
wherein the extracted information from the user terminal is stored as an estimated location vector including the extracted propagation delay and the extracted downlink path loss.

8. The cellular location method of claim 4,
wherein said extracting information from the obtained radio measurements includes extracting a propagation delay between the user terminal and two or more cells within the communications network,
wherein said extracting information from the obtained radio measurements includes extracting a downlink path loss between the user terminal and two or more cells within the communications network, and
wherein the one or more power values include the extracted downlink path loss, and the one of more time values include the extracted propagation delay.

9. A cellular location system for determining a location of a specified user terminal in a communications network, said cellular location system comprising:
an obtaining unit for obtaining radio measurements from a user terminal located in the communications network;
an extracting unit for extracting information from the obtained radio measurements such that the location of the user terminal can be determined;
a determination unit for determining the location of the user terminal based on the extracted information; and
a database for storing the determined location of the user terminal and the extracted information as an entry such that the determined location of the user terminal is retrieved based upon a matching score between the extracted information from the user terminal and extracted information from the specified user terminal.

10. The cellular location system of claim 9, wherein said obtaining unit obtains radio measurements from the user terminal is when the user terminal is in handover.

11. The cellular location system of claim 9, wherein when the determined location of the user terminal is retrieved based upon the matching score between the extracted information from the user terminal and the extracted information from the specified user terminal, the location of the specified user terminal is determined based on the determined location of the user terminal.

12. The cellular location system of claim 9,
wherein the extracted information from the user terminal is stored in the database as an estimated location vector including one or more power values and one or more time measurements for each of n available cells within the communications network,
wherein the extracted information from the specified terminal represented as a measurement vector including one or more power values and one or more time measurements for each of n available cells within the communications network, and
wherein the matching score is computed by calculating a least-mean squares (LMS) difference between the estimated location vector and the measurement vector.

13. The cellular location system of claim 12,
wherein a coefficient weighting, α, is used for calculating an LMS difference between the one or more power values of the estimated location vector and the one or more power values of the measurement vector,
wherein a coefficient weighting, β, is used for calculating an LMS difference between the one or more time values of the estimated location vector and the one or more time values of the measurement vector,
wherein α and β are different values, and
wherein the LMS difference between the estimated location vector and the measurement vector is the sum of the LMS difference between the one of more power values and the LMS difference between the one or more time values.

14. The cellular location system of claim 10,
wherein said extraction unit extracts from the obtained radio measurements, a propagation delay between the user terminal and two or more cells within the communications network, and
wherein the location of the user terminal is determined based on the extracted propagation delay between the user terminal and the two or more cells within the communications network.

15. The cellular location system of claim 14,
wherein said extraction unit extracts from the obtained radio measurements, a downlink path loss between the user terminal and two or more cells within the communications network, and
wherein the extracted information from the user terminal is stored as an estimated location vector including the extracted propagation delay and the extracted downlink path loss.

16. The cellular location system of claim 12,
wherein said extraction unit extracts from the obtained radio measurements, a propagation delay between the user terminal and two or more cells within the communications network,
wherein said extraction unit extracts from the obtained radio measurements, a downlink path loss between the user terminal and two or more cells within the communications network, and
wherein the one or more power values include the extracted downlink path loss, and the one of more time values include the extracted propagation delay.

17. A non-transitory computer readable recording medium having stored thereon a cellular location program that when executed causes a computer to perform a cellular location method for determining a location of a specified user terminal in a communications network, wherein the cellular location method is used in a cellular location system including a database, the cellular location method comprising:
obtaining radio measurements from a user terminal located in the communications network;
extracting information from the obtained radio measurements such that the location of the user terminal can be determined;
determining the location of the user terminal based on the extracted information; and
storing the determined location of the user terminal and the extracted information as an entry in the database such that the determined location of the user terminal is retrieved based upon a matching score between the extracted information from the user terminal and extracted information from the specified user terminal.

18. The non-transitory computer readable recording medium of claim 17, wherein said obtaining radio measurements from the user terminal is performed when the user terminal is in handover.

19. The non-transitory computer readable recording medium of claim 17, wherein when the determined location of the user terminal is retrieved based upon the matching score between the extracted information from the user terminal and the extracted information from the specified user terminal, the location of the specified user terminal is determined based on the determined location of the user terminal.

20. The non-transitory computer readable recording medium of claim 17,
wherein the extracted information from the user terminal is stored in the database as an estimated location vector including one or more power values and one or more time measurements for each of n available cells within the communications network,
wherein the extracted information from the specified terminal is represented as a measurement vector including one or more power values and one or more time measurements for each of n available cells within the communications network,
wherein the matching score is computed by calculating a least-mean squares (LMS) difference between the estimated location vector and the measurement vector,
wherein a coefficient weighting, α, is used for calculating an LMS difference between the one or more power values of the estimated location vector and the one or more power values of the measurement vector,
wherein a coefficient weighting, β, is used for calculating an LMS difference between the estimated location vector and the measurement vector,
wherein α and β are different values,
wherein the LMS difference between the estimated location vector and the measurement vector is the sum of the LMS difference between the one of more power values and the LMS difference between the one or more time values,
wherein said extraction unit extracts from the obtained radio measurements, a propagation delay between the user terminal and two or more cells within the communications network,
wherein said extraction unit extracts from the obtained radio measurements, a downlink path loss between the user terminal and two or more cells within the communications network, and
wherein the one or more power values include the extracted downlink path loss, and the one of more time values include the extracted propagation delay.
